(19) United States
(12) Patent Application Publication
(10) Pub. No.: US 2015/0301738 A1
(43) Pub. Date: Oct. 22, 2015

(54) MOBILE TERMINAL DEVICE, NON-TRANSITORY COMPUTER READABLE STORAGE MEDIUM, AND DISPLAY CONTROL METHOD

(71) Applicant: KYOCERA Corporation, Kyoto-shi (JP)

(72) Inventor: Atsuo NISHIGAKI, Osaka (JP)

(73) Assignee: KYOCERA Corporation

(21) Appl. No.: 14/712,736

(22) Filed: May 14, 2015

Related U.S. Application Data
(63) Continuation of application No. PCT/JP2013/080705, filed on Nov. 13, 2013.

(30) Foreign Application Priority Data
Nov. 14, 2012 (JP) 2012-250568

(51) Int. Cl. G06F 3/0488; G06F 3/16; G06F 3/0484

(52) U.S. Cl. CPC G06F 3/04883; G06F 3/04847; G06F 3/04842; G06F 3/165

(57) ABSTRACT

A mobile terminal device and methods are disclosed. A display module includes a display surface. An operation receiving module receives a first operation and a second operation from a user. A control module configured to set a locked state, release the locked state if the first operation and the second operation are received, display a predetermined screen in a first display direction associated with the first release operation if the first release operation is received, and display the predetermined screen in a second display direction associated with the second release operation if the second release operation is received.

The present application is a bypass continuation of international application PCT Application No. PCT/JP2013/080705, filed Nov. 13, 2013, entitled “PORTABLE TERMINAL DEVICE, PROGRAM, AND DISPLAY CONTROL METHOD”, which claims priority under 35 U.S.C. Section 119 of Japanese Patent Application No. 2012-250568 filed Nov. 14, 2012, entitled “MOBILE TERMINAL DEVICE, PROGRAM, AND DISPLAY CONTROL METHOD”. The disclosure of the above applications are incorporated herein by reference.

### FIELD

Embodiments of the present disclosure relates to a mobile terminal device such as a mobile phone, a PDA (Personal Digital Assistant), a tablet PC, and an electronic book terminal. Embodiments of the present disclosure also relates to a non-transitory computer readable storage medium suitable for use in the mobile terminal device, and to a display control method suitable for use in the mobile terminal device.

### BACKGROUND

Conventionally, there are known mobile phones provided with a touch panel on a display surface thereof, and configured to execute various application programs (hereinafter, simply called as “applications”), based on a user's touch operation with respect to the display surface. The mobile phones as described above may have a simplified outer shape such that a substantially rectangular-shaped display surface of a size slightly smaller than a substantially rectangular-shaped mobile phone housing is formed on the front surface of the housing.

### SUMMARY

A mobile terminal device and methods are disclosed. A display module includes a display surface. An operation receiving module receives a first operation and a second operation from a user. A control module configured to set a locked state, release the locked state if the first operation and the second operation are received, display a predetermined screen in a first display direction associated with the first release operation if the first release operation is received, and display the predetermined screen in a second display direction associated with the second release operation if the second release operation is received.

In one embodiment, a method for controlling a mobile terminal device comprising a display module including a display surface configured to receive a first operation and a second operation from a user. The method then includes setting a locked state. The method then includes releasing the locked state if the first operation and the second operation are received. The method then includes displaying a predetermined screen in a first display direction associated with the first release operation if the first release operation is received. The method then includes displaying the predetermined screen in a second display direction associated with the second release operation if the second release operation is received.

### BRIEF DESCRIPTION OF THE DRAWINGS

FIGS. 1A and 1B are diagrams of a configuration of a mobile phone in an embodiment;

FIG. 2 is a block diagram of the overall configuration of the mobile phone in an embodiment;

FIGS. 3A to 3C are diagrams for describing a lock release screen in an embodiment;

FIG. 4 is a diagram for describing a home screen in an embodiment;

FIG. 5 is a flowchart of a lock release process in an embodiment;

FIGS. 6A and 6B are diagrams for describing how a screen transition when a lock release operation is performed in an embodiment;

FIGS. 7A and 7B are diagrams for describing a lock release screen in a first modification;

FIG. 8 is a flowchart of a lock release process in the first modification;

FIGS. 9A and 9B are diagrams for describing how a screen transition when a lock release operation is performed in the first modification;

FIGS. 10A and 10B are diagrams of a configuration of a mobile phone in a second modification;

FIG. 11 is a flowchart of a setting switching process in the second modification;

FIGS. 12A and 12B are diagrams of a configuration of a mobile phone in a third modification;

FIG. 13 is a flowchart of a setting switching process in the third modification;

FIGS. 14A and 14B are diagrams for describing a lock release screen in another modification; and

FIGS. 15A and 15B are diagrams for describing a lock release screen in another modification.

The drawings are provided for purpose of illustration only, and do not limit the scope of the present disclosure.

### DESCRIPTION OF PREFERRED EMBODIMENTS

In the following, an embodiment of the present disclosure is described referring to the drawings.

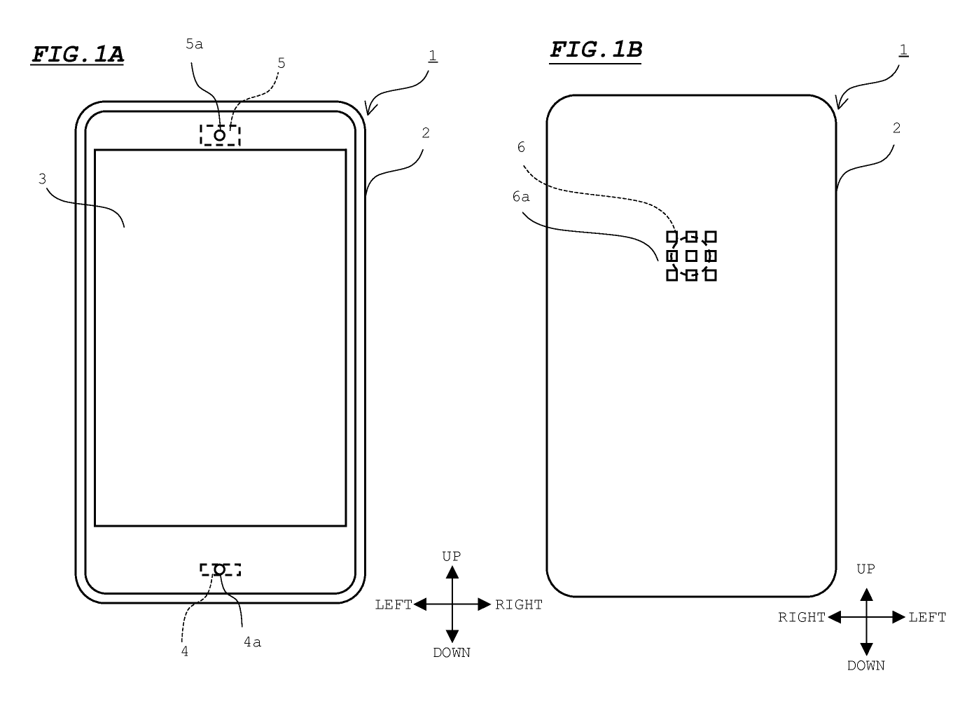

FIGS. 1A and 1B are diagrams of a configuration of a mobile phone 1. FIGS. 1A and 1B are respectively a front view and a rear view of the mobile phone 1.

In the following, to simplify the description, as illustrated in FIGS. 1A and 1B, the long side direction of a cabinet 2 is defined as up and down directions, and the short side direction of the cabinet 2 is defined as left and right directions.

The mobile phone 1 may include the cabinet 2, a display surface 3, a microphone 4, a call speaker 5, and an external speaker 6.

The cabinet 2 may have a substantially rectangular contour when viewed from the front side. The display surface 3 of a display module 13 to be described later may be disposed on the front surface of the cabinet 2. Various images (screens) are displayed on the display surface 3.

The microphone 4 may be disposed at a lower end within the cabinet 2, and the call speaker 5 may be disposed at an upper end within the cabinet 2. Sound is input through a microphone hole 4a formed in the front surface of the cabinet 2. The microphone 4 generates an electrical signal in accordance with input sound. Sound is output from the call speaker 5. The output sound is released to the outside through an output hole 5a formed in the front surface of the cabinet 2. When a phone call is made, sound received from a communication partner device (such as a mobile phone) is output from the call speaker 5, and sound uttered by the user is input to the microphone 4.

The external speaker 6 may be disposed in the cabinet 2. Output holes 6a associated with the external speaker 6 are formed in the back surface of the cabinet 2. Sound (such as voice or alarm) output from the external speaker 6 is released to the outside through the output holes 6a.

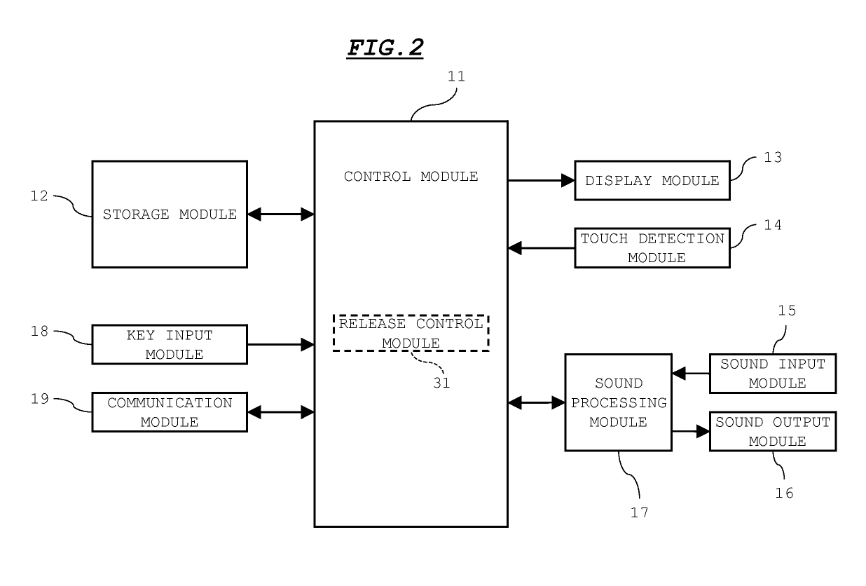

FIG. 2 is a block diagram of the overall configuration of the mobile phone 1. The mobile phone 1 may include a control module 11, a storage module 12, the display module 13, a touch detection module 14, a sound input module 15, a sound output module 16, a sound processing module 17, a key input module 18, and a communication module 19.

The storage module 12 may include an ROM, an RAM, and an external memory. The storage module 12 stores therein various programs. The programs stored in the storage module 12 include, in addition to a control program for controlling the modules of the mobile phone 1, various applications (e.g. applications relating to a phone, an e-mail, a map, a game, and a schedule management). The programs may be stored in the storage module 12 when the mobile phone 1 is manufactured by the manufacturer, or may be stored in the storage module 12 by the user via a communication network or a storage medium such as a memory card.

The storage module 12 may also include a working area for storing data to be temporarily used or generated when a program is executed.

The control module 11 may include a CPU. The control module 11 controls the modules constituting the mobile phone 1 (such as the storage module 12, the display module 13, the touch detection module 14, the sound input module 15, the sound output module 16, the sound processing module 17, the key input module 18, and the communication module 19) in accordance with a program.

The display module 13 may include a liquid crystal display. The display module 13 displays an image (a screen) on the display surface 3, based on a control signal and an image signal from the control module 11. The display module 13 may include another display device such as an organic EL display, in place of a liquid crystal display.

The touch detection module 14 may include a touch panel configured to detect touch of the display surface 3 by the fingertip. The touch panel may be formed of a transparent sheet-like member, and may be disposed on the front surface of the cabinet 2 in such a manner as to cover the display surface 3. The touch panel may be any one of various types of touch panels such as an electrostatic capacitive touch panel, an ultrasonic touch panel, a pressure sensitive touch panel, a resistive touch panel, and a photosensitive touch panel.

The touch detection module 14 receives a user's touch operation onto the display surface 3. Specifically, the touch detection module 14 detects a position on the display surface 3 where the fingertip has touched, that is a touch position, and outputs a position signal indicating the detected touch position to the control module 11.

The user is allowed to perform various touch operations by touching the display surface 3 by the fingertip. Examples of the touch operations are a tap operation, a flick operation, and a slide operation. The tap operation is an operation of touching the display surface 3 by the fingertip, and then releasing the fingertip from the display surface 3 within a short time. The flick operation is an operation of flicking the display surface 3 in an arbitrary direction with the fingertip. The slide operation is an operation of moving the fingertip on the display surface 3 in an arbitrary direction while keeping the fingertip in contact with the display surface 3. The flick operation and the slide operation are touch operations accompanying movement of a touch position.

The touch operations are described in detail. For instance, when after a touch position with respect to the display surface 3 is detected by the touch detection module 14, the touch position cannot be detected any more within a predetermined first time, the control module 11 determines that a tap operation has been performed. When after a touch position with respect to the display surface 3 is detected by the touch detection module 14 and the touch position is moved by a predetermined first distance or more within a predetermined second time, the touch position cannot be detected any more, the control module 11 determines that a flick operation has been performed. When after a touch position with respect to the display surface 3 is detected by the touch detection module 14, the touch position is moved by a predetermined second distance or more, the control module 11 determines that a slide operation has been performed.

The sound input module 15 may include the microphone 4. The sound input module 15 outputs an electrical signal from the microphone 4 to the sound processing module 17.

The sound output module 16 may include the call speaker 5 and the external speaker 6. The sound output module 16 receives an electrical signal from the sound processing module 17, and outputs sound (such as voice or alarm) from the call speaker 5 or from the external speaker 6.

The sound processing module 17 performs e.g. A/D conversion to an electrical signal from the sound input module 15, and outputs a digital sound signal which has undergone A/D conversion to the control module 11. The sound processing module 17 performs e.g. a decoding process and D/A conversion to the digital sound signal output from the control module 11, and outputs an electrical signal which has undergone D/A conversion to the sound output module 16.

In response to pressing of various hard keys (not illustrated) provided in the mobile phone 1, such as a power key for use in turning on the mobile phone 1, the key input module 18 outputs a signal associated with the pressed hard key to the control module 11.

The communication module 19 may include a circuit for converting a signal, and an antenna for transmitting and receiving a radio wave in order to make a phone call or to perform communication. The communication module 19 converts a signal to be input from the control module 11 for a phone call or for communication into a wireless signal, and transmits the converted wireless signal to a communication destination such as a base station or another communication device via the antenna. Further, the communication module 19 converts the wireless signal received via the antenna into a signal of a format usable by the control module 11, and outputs the converted signal to the control module 11.

The mobile phone 1 in an embodiment is provided with a locking function. When a predetermined time elapses without a user's touch operation with respect to the display surface 3 or without a user's operation with respect to a hard key, the locking function is operated, and a screen such as a home screen, on which the user has performed various operations, is closed. Then, the mobile phone 1 is brought to a locked state, in which receiving of a touch operation with respect to the display surface 3 or at least a part of operations with respect to the hard keys is restrained. When the user wishes to operate the mobile phone 1 again, the user performs a predetermined operation such as pressing a specific hard key so as to display a lock release screen on the display surface 3. Subsequently, the user performs a predetermined release operation on the lock release screen. When the locked state is released based on the release operation, for instance, a home screen is displayed.

As illustrated in FIGS. 1A and 1B, the mobile phone 1 has a simplified outer shape such that the display surface 3 is formed on the front surface of the substantially square shaped cabinet 2. Therefore, the user may find it difficult to know the upper side and the lower side of the mobile phone 1 at a glance, and may inadvertently hold the mobile phone 1 upside down.

When the mobile phone 1 is held by the user in a vertical orientation, the display direction of a screen (such as a home screen) to be displayed after a locked state is released directs from the upper side of the mobile phone 1 to the lower side thereof. Therefore, when the user inadvertently holds the mobile phone 1 upside down, the user is required to re-hold the mobile phone 1 so that the orientation of the mobile phone 1 coincides with a proper orientation each time the mobile phone 1 is held upside down.

In an embodiment, the control module 11 executes a lock release process such that the display direction of a screen after a locked state is released coincides with a direction associated with the orientation of the mobile phone 1 held by the user simply when the user performs an operation of releasing the locked state.

In order to execute the lock release process, the control module 11 may include a release control module 31. The release control module 31 may be implemented as a function of a program to be executed by the control module 11.

The release control module 31 displays a lock release screen on the display surface 3.

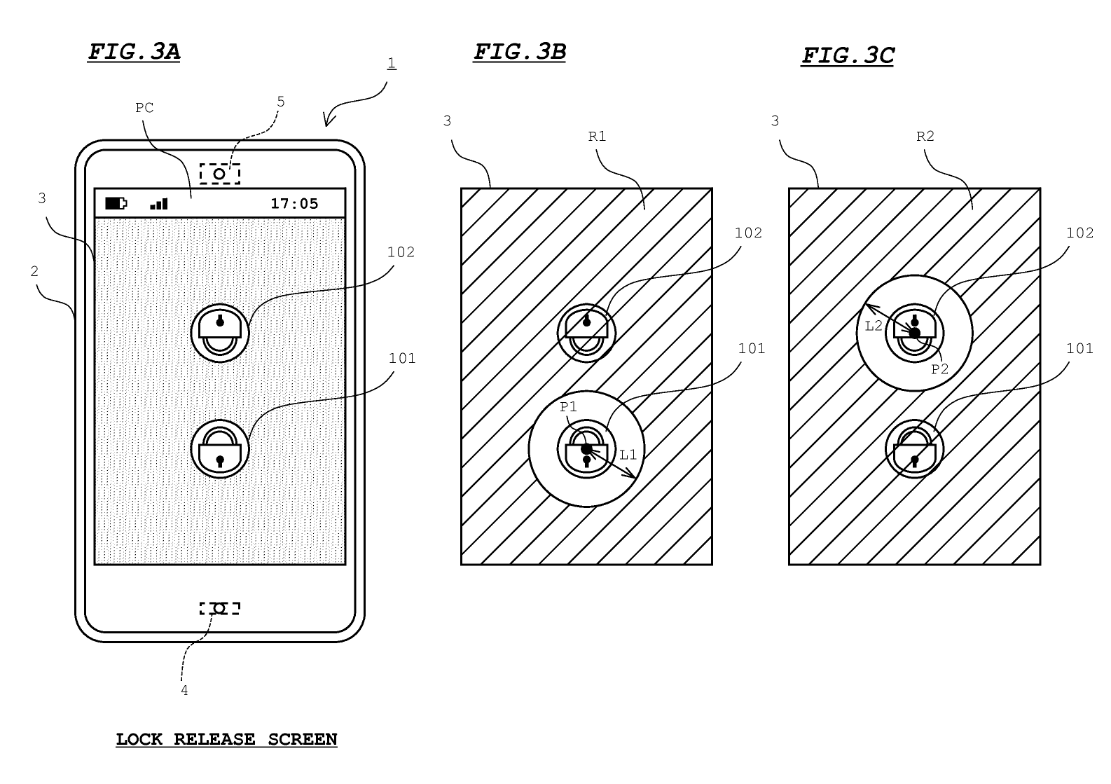

FIG. 3A is a diagram of an example of the lock release screen. As illustrated in FIG. 3A, the lock release screen includes a first release object 101 and a second release object 102. The first release object 101 and the second release object 102 are objects to be operated in order to release a locked state.

The first release object 101 is displayed at a position slightly lower than the middle of a lock release screen. This position is the initial display position of the first release object 101. The first release object 101 includes display of a lock directing from the upper side of the cabinet 2 (mobile phone 1) to the lower side thereof.

The second release object 102 is displayed at a position slightly upper than the middle of the lock release screen. This position is an initial display position of the second release object 102. The second release object 102 includes display of a lock directing from the lower side of the cabinet 2 (mobile phone 1) to the upper side thereof.

In an embodiment, each of the first release object 101 and the second release object 102 is in the form of a circular button with display of a lock. Alternatively, the first release object 101 and the second release object 102 may have a shape of a lock itself, in place of a circular shaped button.

Further, the lock release screen includes a pictorial area PC at an upper end thereof. A current time, a residual amount meter indicating the residual amount of battery, and an intensity meter indicating the intensity of a radio wave are displayed in the pictorial area PC.

The release control module 31 sets a first release area R1 associated with the first release object 101, and a second release area R2 associated with the second release object 102 on a lock release screen.

FIG. 3B is a diagram for describing the first release area R1. To simplify the description, in FIG. 3B, the first release area R1 is indicated by a diagonal line portion. On an actual lock release screen, however, the first release area R1 is not displayed.

As illustrated in FIG. 3B, an entire display area on the display surface 3, except for a hypothetical circle having the radius L1 with respect to the center P1 of the initial display position of the first release object 101, is set as the first release area R1. The whole circumference of the first release object 101 is surrounded by the first release area R1.

FIG. 3C is a diagram for describing the second release area R2. To simplify the description, in FIG. 3C, the second release area R2 is indicated by a diagonal line portion. On an actual lock release screen, however, the second release area R2 is not displayed.

As illustrated in FIG. 3C, an entire display area on the display surface 3, except for a hypothetical circle having the radius L2 with respect to the center P2 of the initial display position of the second release object 102, is set as the second release area R2. The whole circumference of the second release object 102 is surrounded by the second release area R2.

When a flick operation is performed with respect to the first release object 101 or with respect to the second release object 102, the release control module 31 determines the position of the moving destination to which the first release object 101 or the second release object 102 is to be moved, based on the direction and the speed of the flick operation. The storage module 12 stores therein a lookup table representing a relationship between the speed of a flick operation (a value associated with a speed, e.g. a distance by which a touch position is moved within the second time), and the moving distance of the first release object 101 or of the second release object 102. The release control module 31 obtains a moving distance associated with the speed of the flick operation, referring to the lookup table, and determines the position of the moving destination from the obtained moving distance and the direction of the flick operation. Alternatively, the storage module 12 may store an operation expression for calculating a moving distance of the first release object 101 or of the second release object 102 from the speed of the flick operation, in place of the lookup table.

When a flick operation such that the position of the moving destination is within the first release area R1 is performed with respect to the first release object 101, the release control module 31 releases the locked state, and displays a home screen on the display surface 3, whose display direction coincides with a direction from the upper side of the mobile phone 1 to the lower side thereof. On the other hand, when a flick operation such that the position of the moving destination is within the second release area R2 is performed with respect to the second release object 102, the release control module 31 releases the locked state, and displays a home screen on the display surface 3, whose display direction coincides with a direction from the lower side of the mobile phone 1 to the upper side thereof.

Further, when a slide operation such that the release position is within the first release area R1 is performed with respect to the first release object 101, the release control module 31 releases the locked state, and displays a home screen on the display surface 3, whose display direction coincides with a direction from the upper side of the mobile phone 1 to the lower side thereof. On the other hand, when a slide operation such that the release position is within the second release area R2 is performed with respect to the second release object 102, the release control module 31 releases the locked state, and displays a home screen on the display surface 3, whose display direction coincides with a direction from the lower side of the mobile phone 1 to the upper side thereof.

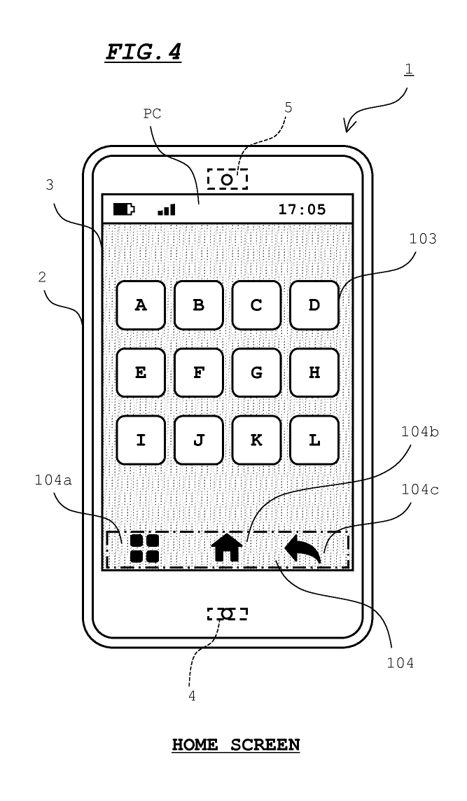

FIG. 4 is a diagram of an example of a home screen. The home screen includes icons 103 associated with various applications. When a tap operation is performed by the user with respect to one of the icons 103, an application associated with the icon 103 is activated.

Further, the home screen includes an operation key group 104. The operation key group 104 is constituted of a setting key 104a, a home key 104b, and a back key 104c. The setting key 104a is a key mainly configured to display, on the display surface 3, a setting screen on which the user performs various settings. The home key 104b is a key mainly configured to shift display of the display surface 3 from a screen other than a home screen to the home screen. The back key 104c is a key mainly configured to return an executed process to an immediately preceding process.

Further, the home screen includes a pictorial area PC at an upper end thereof as well as the lock release screen.

In the following, a lock release process in an embodiment is described in detail.

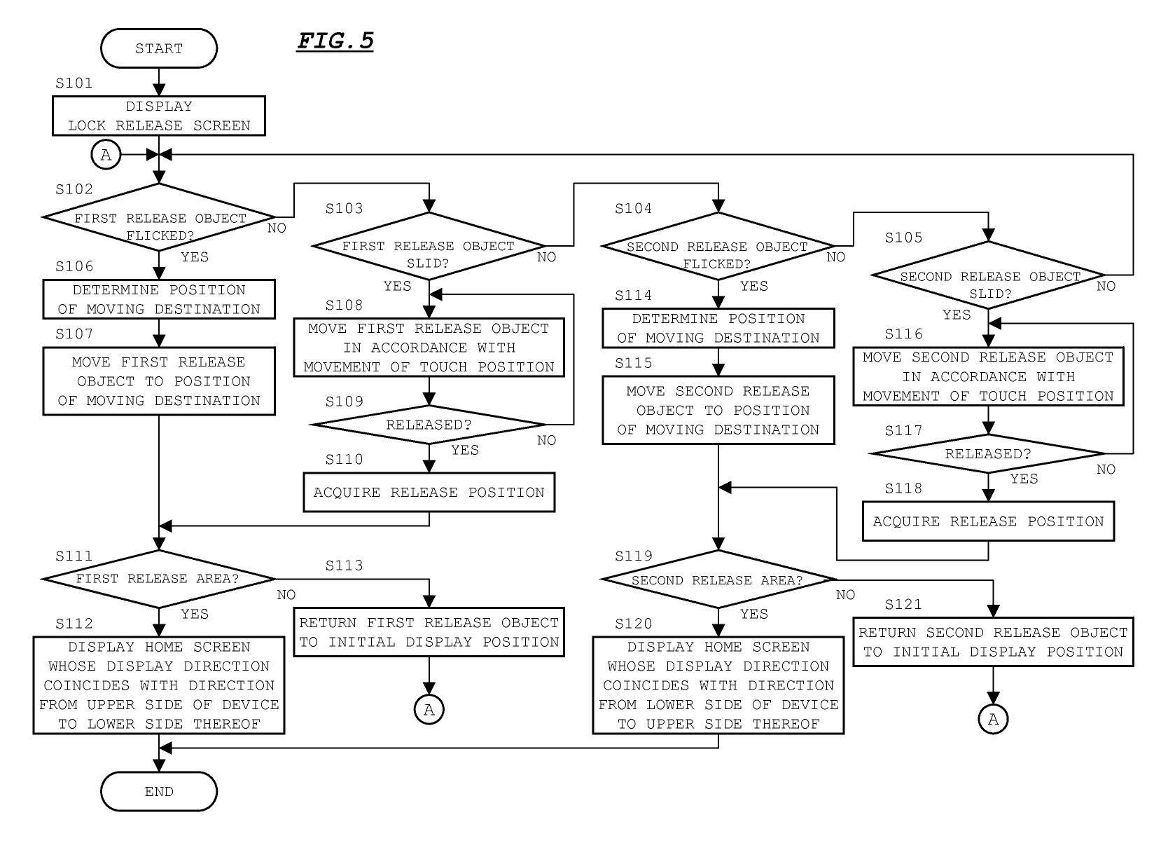

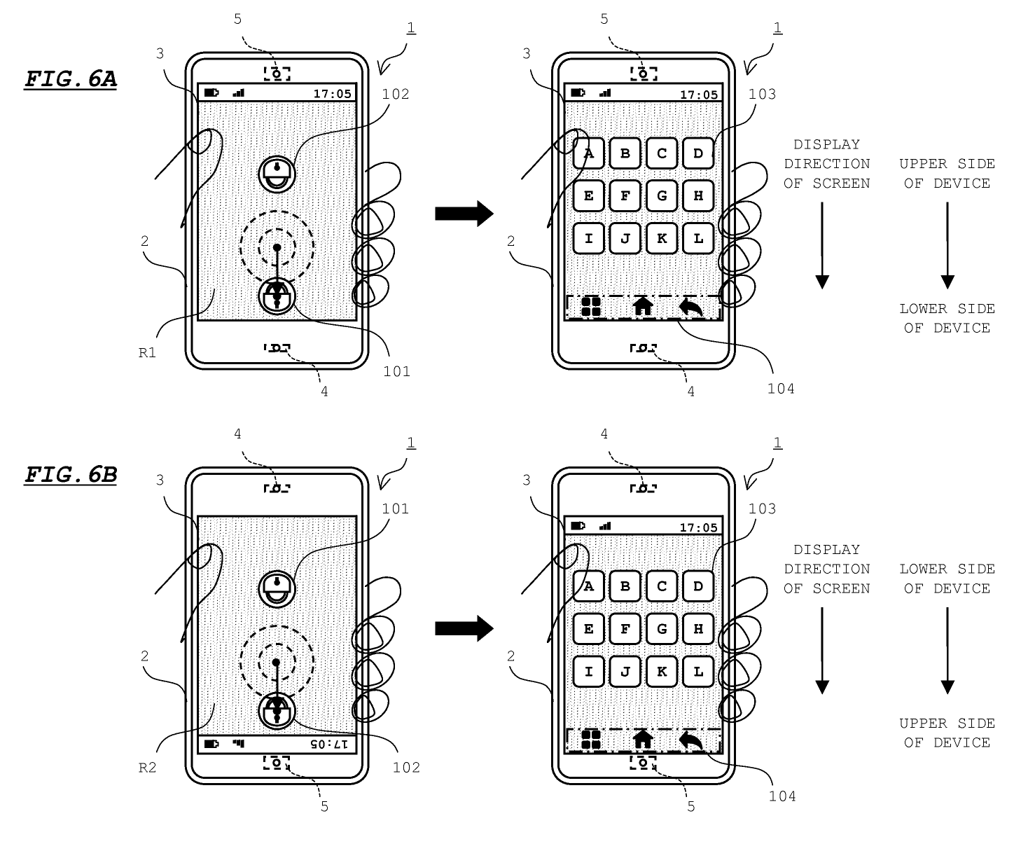

FIG. 5 is a flowchart of a lock release process. FIG. 6A is a diagram for describing how a screen transition when the user performs a lock release operation, while holding the mobile phone 1 in a proper orientation. FIG. 6B is a diagram for describing how a screen transition when the user performs a lock release operation, while holding the mobile phone 1 upside down.

When the process is started, the release control module 31 displays the lock release screen illustrated in FIG. 3A on the display surface 3 (S101). Subsequently, the release control module 31 determines whether a flick operation is performed with respect to the first release object 101, and determines whether a slide operation is performed with respect to the first release object 101 (S102, S103). Further, the release control module 31 determines whether a flick operation is performed with respect to the second release object 102, and determines whether a slide operation is performed with respect to the second release object 102 (S104, S105).

As illustrated in FIG. 6A, when the user performs a lock release operation while holding the mobile phone 1 in a proper orientation, the user performs a flick operation or a slide operation with respect to the first release object 101, in which a lock is displayed in a proper orientation in an intended direction e.g. in a downward direction (see the left drawing in FIG. 6A). The “proper orientation” of the mobile phone 1 is an orientation such that the lower side of the mobile phone 1 faces the ground when the user holds the mobile phone 1 in an upright posture; and is an orientation such that the lower side of the mobile phone 1 faces the user when the user holds the mobile phone 1 in a horizontal posture.

When it is determined that a flick operation is performed with respect to the first release object 101 (S102: YES), as described above, the release control module 31 obtains a moving distance of the first release object 101 (center of the object) from the speed of the flick operation, referring to the lookup table. Subsequently, the release control module 31 determines the position of the moving destination of the first release object 101, based on the obtained moving distance and the direction of the flick operation (S106). The direction of a flick operation is obtained from the first touch position and the release position of the flick operation. The release control module 31 controls the first release object 101 to move to the position of the moving destination on the lock release screen (S107).

When it is determined that a slide operation is performed with respect to the first release object 101 (S103: YES), the release control module 31 controls the first release object 101 to move in accordance with movement of a touch position on the lock release screen (S108). The release control module 31 determines whether the fingertip is released from the first release object 101, in other words, from the display surface 3 (S109). When it is determined that the fingertip is released (S109: YES), the release control module 31 acquires the release position (S110).

Subsequently, the release control module 31 determines whether the position of the moving destination when a flick operation is performed with respect to the first release object 101 is within the first release area R1, or the release position when a slide operation is performed with respect to the first release object 101 is within the first release area R1 (S111).

When a flick operation is performed with respect to the first release object 101 by the user at a sufficiently high speed, and when a slide operation is performed with respect to the first release object 101 by the user by a sufficiently long distance, the first release object 101 is moved to the first release area R1. In this case, the release control module 31 determines that the position of the moving destination of the first release object 101 or the release position of the first release object 101 is within the first release area R1 (S111: YES), and closes the lock release screen. Subsequently, as illustrated in the right drawing of FIG. 6A, the release control module 31 displays a home screen on the display surface 3, whose display direction coincides with a direction from the upper side of the mobile phone 1 to the lower side thereof (S112). In this way, the lock release process is finished.

When a flick operation or a slide operation with respect to the first release object 101 is not sufficient, the position of the moving destination of the first release object 101 may not reach the first release area R1, or the first release object 101 may be released before the first release object 101 reaches the first release area R1. In this case, the release control module 31 determines that the position of the moving destination or the release position is not within the first release area R1 (S111: NO), and controls the first release object 101 to return to the initial display position (S113).

On the other hand, as illustrated in FIG. 6B, when the user performs a lock release operation while holding the mobile phone 1 upside down, the user is allowed to perform a flick operation or a slide operation with respect to the second release object 102, in which a lock is displayed in a proper orientation, in an intended direction e.g. in a downward direction (see the left drawing in FIG. 6B).

When it is determined that a flick operation is performed with respect to the second release object 102 (S104: YES), the release control module 31 determines the position of the moving destination of the second release object 102 in the same manner as the case of the first release object 101 (S114), and controls the second release object 102 to move to the position of the moving destination on the lock release screen (S115).

When it is determined that a slide operation is performed with respect to the second release object 102 (S105: YES), the release control module 31 controls the second release object 102 to move in accordance with movement of a touch position on the lock release screen in the same manner as the case of the first release object 101 (S116). Subsequently, when it is determined that the fingertip is released from the display surface 3 (S117: YES), the release control module 31 acquires the release position (S118).

The release control module 31 determines whether the position of the moving destination of the second release object 102 or the release position of the second release object 102 is within the second release area R2 (S119). When it is determined that the position of the moving destination of the second release object 102 or the release position of the second release object 102 is within the second release area R2 (S119: YES), the release control module 31 closes the lock release screen. Subsequently, as illustrated in the right drawing of FIG. 6B, the release control module 31 displays a home screen on the display surface 3, whose display direction coincides with a direction from the lower side of the mobile phone 1 to the upper side thereof (S120). In this way, the lock release process is finished.

As well as the case of the first release object 101, when it is determined that the position of the moving destination of the second release object 102 or the release position of the second release object 102 is not within the second release area R2 (S119: NO), the release control module 31 controls the second release object 102 to return to the initial display position (S121).

As described above, according to an embodiment, when the user performs an operation of releasing a locked state, the user is allowed to display, on the display surface 3, a screen to be displayed after the locked state is released (e.g. a home screen) in a display direction appropriate for the orientation of the mobile phone 1 held by the user without performing an additional operation.

According to an embodiment, it is possible to implement the user-friendly mobile phone 1.

Further, according to an embodiment, the first release object 101 and the second release object 102 are respectively configured to be displayed on a lock release screen in association with a display direction of a screen after a locked state is released. This makes it possible to release a locked state when a release object (the first release object 101 or the second release object 102) for releasing the locked state is moved in any direction.

Furthermore, according to an embodiment, the first release object 101 and the second release object 102 are configured to include display indicating the display direction of a screen after a locked state is released. This makes it easy for the user to select a release object associated with a display direction of an intended screen.

### First Modification

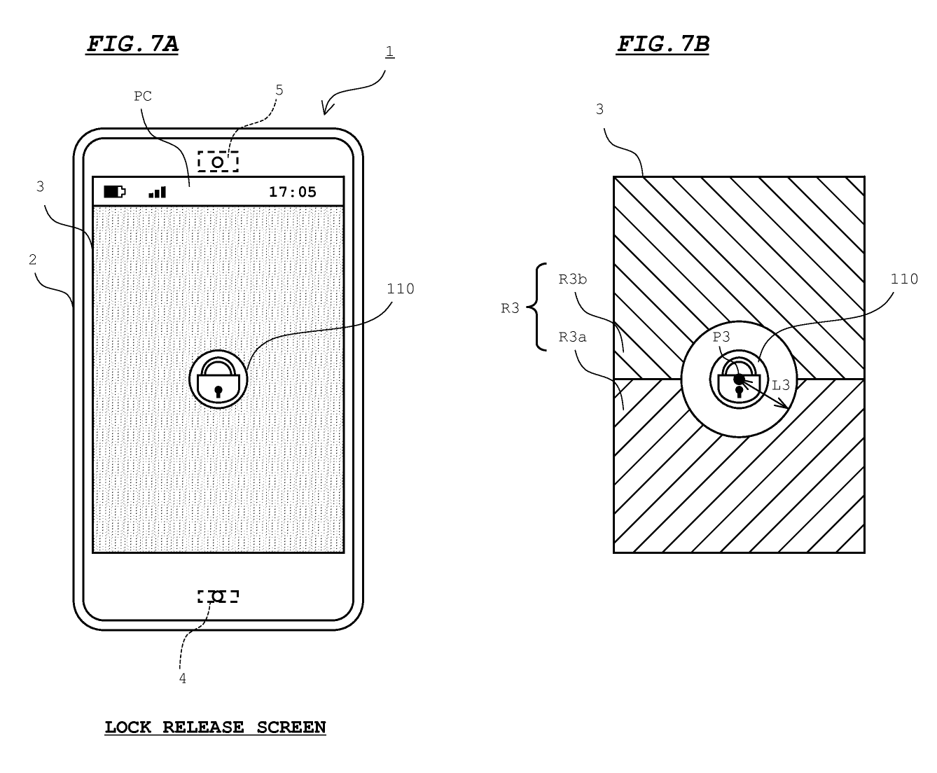

FIG. 7A is a diagram of an example of a lock release screen in a first modification.

A release control module 31 displays a lock release screen illustrated in FIG. 7A on a display surface 3, in place of the lock release screen illustrated in FIG. 3A. As illustrated in FIG. 7A, the lock release screen includes a third release object 110. In other words, in the present modification, one release object is displayed on a lock release screen. The third release object 110 is displayed substantially at the middle of the lock release screen. This position is the initial display position of the third release object 110. The third release object 110 includes display of a lock directing from the upper side of a cabinet 2 (mobile phone 1) to the lower side thereof.

In the present modification, the third release object 110 is in the form of a circular button with display of a lock. Alternatively, the third release object 110 may have a shape of a lock itself, in place of a circular shaped button.

The release control module 31 sets a third release area R3 associated with the third release object 110 on a lock release screen.

FIG. 7B is a diagram for describing the third release area R3. To simplify the description, in FIG. 7B, the third release area R3 (a lower area R3a and an upper area R3b) is indicated by a diagonal line portion. On an actual lock release screen, however, the third release area R3 is not displayed.

As illustrated in FIG. 7B, an entire display area on the display surface 3, except for a hypothetical circle having the radius L3 with respect to the center P3 of the initial display position of the third release object 110, is set as the third release area R3. The whole circumference of the third release object 110 is surrounded by the third release area R3. The third release area R3 is constituted of the lower area R3a on the lower side with respect to the center P3 of the initial display position of the third release object 110, and of the upper area R3b on the upper side with respect to the center P3.

When a flick operation (a slide operation) such that the position of the moving destination (the release position) is within the lower area R3a is performed with respect to the third release object 110, the release control module 31 releases a locked state, and displays a home screen on the display surface 3, whose display direction coincides with a direction from the upper side of the mobile phone 1 to the lower side thereof. On the other hand, when a flick operation (a slide operation) such that the position of the moving destination (the release position) is within the upper area R3b is performed with respect to the third release object 110, the release control module 31 releases a locked state, and displays a home screen on the display surface 3, whose display direction coincides with a direction from the lower side of the mobile phone 1 to the upper side thereof.

In the following, a lock release process in the present modification is described in detail.

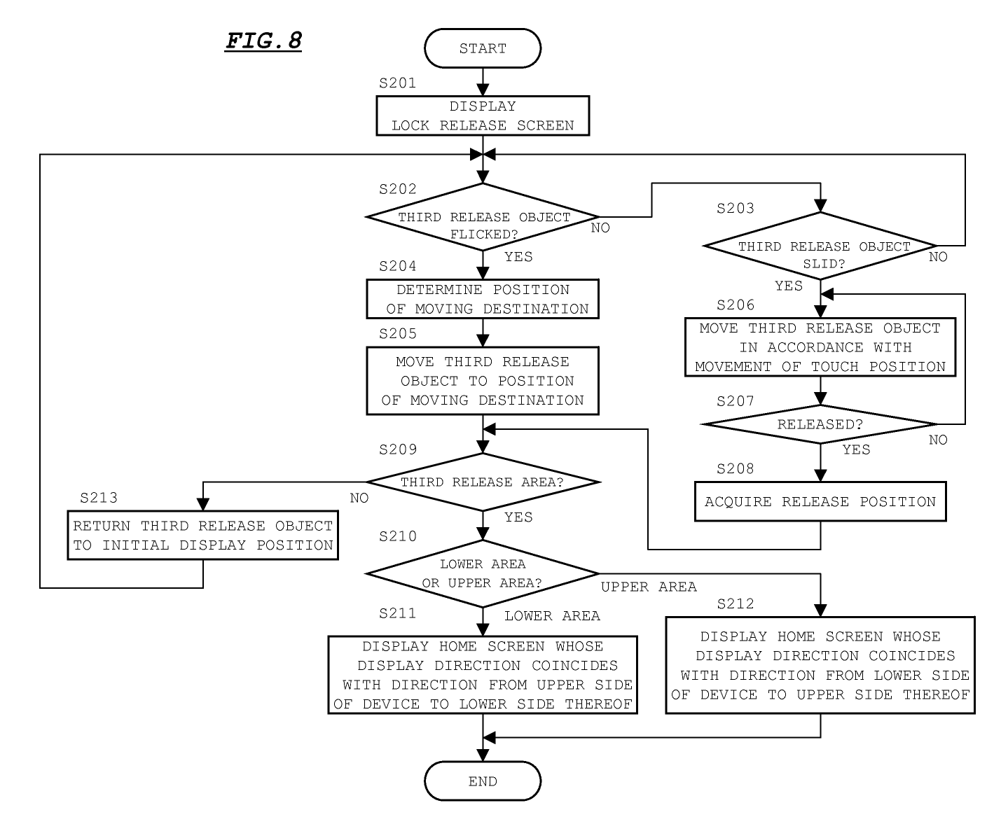

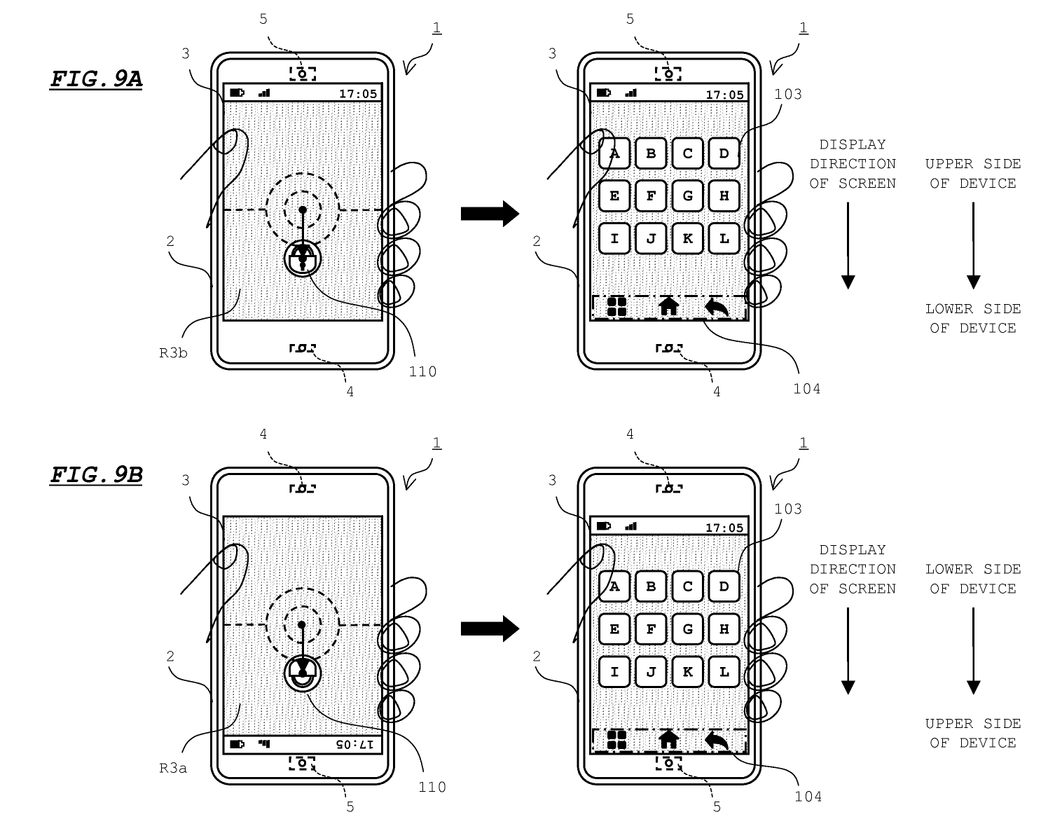

FIG. 8 is a flowchart of a lock release process in the present modification. FIG. 9A is a diagram for describing how a screen transition when the user performs a lock release operation, while holding the mobile phone 1 in a proper orientation. FIG. 9B is a diagram for describing how a screen transition when the user performs a lock release operation while holding the mobile phone 1 upside down.

When the process is started, the release control module 31 displays the lock release screen illustrated in FIG. 7A on the display surface 3 (S201). Subsequently, the release control module 31 determines whether a flick operation is performed with respect to the third release object 110, and determines whether a slide operation is performed with respect to the third release object 110 (S202, S203).

When it is determined that a flick operation is performed with respect to the third release object 110 (S202: YES), the release control module 31 determines the position of the moving destination of the third release object 110 by the same method as described in an embodiment (S204). The release control module 31 controls the third release object 110 to move to the position of the moving destination on the lock release screen (S205).

When it is determined that a slide operation is performed with respect to the third release object 110 (S203: YES), the release control module 31 controls the third release object 110 to move in accordance with movement of a touch position on the lock release screen (S206). When it is determined that the fingertip is released (S207: YES), the release control module 31 acquires the release position (S208).

The release control module 31 determines whether the position of the moving destination of the third release object 110 or the release position of the third release object 110 is within the third release area R3 (S209). When it is determined that the position of the moving destination or the release position is within the third release area R3 (S209: YES), the release control module 31 determines whether the position of the moving destination or the release position is within the lower area R3a or within the upper area R3b (S210).

As illustrated in FIG. 9A, when the user performs a lock release operation while holding the mobile phone 1 in a proper orientation, the user performs a flick operation or a slide operation with respect to the third release object 110 in the downward direction of the mobile phone 1, namely, toward the lower area R3a so that the direction of the flick operation or the slide operation coincides with a display direction of a home screen after a locked state is released (see the left drawing in FIG. 9A).

When it is determined that the position of the moving destination of the third release object 110 or the release position of the third release object 110 is within the lower area R3a (LOWER AREA in Step S210), the release control module 31 closes the lock release screen, and displays a home screen on the display surface 3, whose display direction coincides with a direction from the upper side of the mobile phone 1 to the lower side thereof, as illustrated in the right drawing of FIG. 9A (S211). In this way, the lock release process is finished.

On the other hand, as illustrated in FIG. 9B, when the user performs a lock release operation while holding the mobile phone 1 upside down, the user is allowed to perform a flick operation or a slide operation with respect to the third release object 110 in the upward direction of the mobile phone 1, namely, toward the upper area R3b so that the direction of the flick operation or the slide operation coincides with a display direction of a home screen after a locked state is released (see the left drawing in FIG. 9B).

When it is determined that the position of the moving destination of the third release object 110 or the release position of the third release object 110 is within the upper area R3b (UPPER AREA in Step S210), the release control module 31 closes the lock release screen, and displays a home screen on the display surface 3, whose display direction coincides with a direction from the lower side of the mobile phone 1 to the upper side thereof, as illustrated in the right drawing of FIG. 9B (S212). In this way, the lock release process is finished.

In Step S209, when it is determined that the position of the moving destination of the third release object 110 or the release position of the third release object 110 is not within the third release area R3 (S209: NO), the release control module 31 controls the third release object 110 to return to the initial display position (S213).

As described above, according to the present modification, it is possible to implement the user-friendly mobile phone 1, as well as an embodiment.

### Second Modification

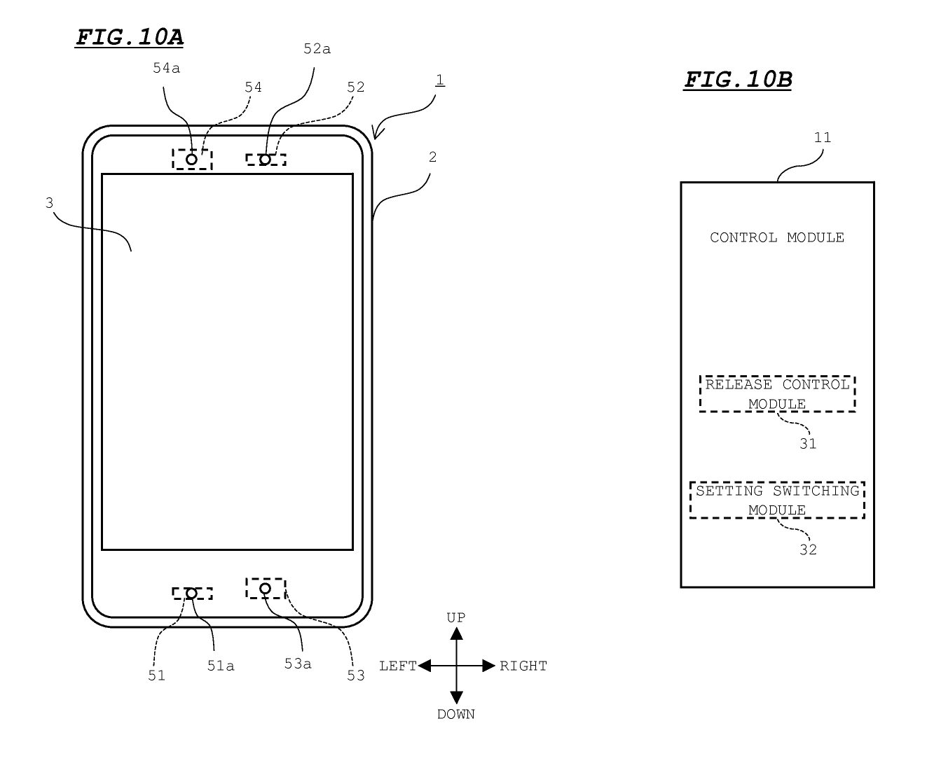

FIGS. 10A and 10B are diagrams of a configuration of a mobile phone 1 in a second modification. FIG. 10A is a front view of the mobile phone 1, and FIG. 10B is a diagram of a configuration of a control module 11.

As illustrated in FIG. 10A, in the present modification, a lower microphone 51 and an upper microphone 52 may be disposed at a lower end and an upper end of a cabinet 2, respectively. The configuration of the lower microphone 51 and of the upper microphone 52 is the same as the microphone 4 in an embodiment. Sound is input to the lower microphone 51 and to the upper microphone 52 through a lower microphone hole 51a and through an upper microphone hole 52a, respectively.

Further, in the present modification, a lower call speaker 53 and an upper call speaker 54 may be disposed at a lower end and an upper end of the cabinet 2, respectively. The configuration of the lower call speaker 53 and of the upper call speaker 54 is the same as the call speaker 5 in an embodiment. Sound output through the lower call speaker 53 and through the upper call speaker 54 is respectively released to the outside through a lower output hole 53a and through an upper output hole 54a.

As illustrated in FIG. 10B, the control module 11 may include a setting switching module 32, in addition to a release control module 31. The setting switching module 32 may be implemented as a function of a program to be executed by the control module 11.

The setting switching module 32 executes a setting switching process of switching between setting the lower microphone 51 and the upper call speaker 54 as a microphone to be operated and a speaker to be operated, respectively, and setting the upper microphone 52 and the lower call speaker 53 as a microphone to be operated and a speaker to be operated, respectively.

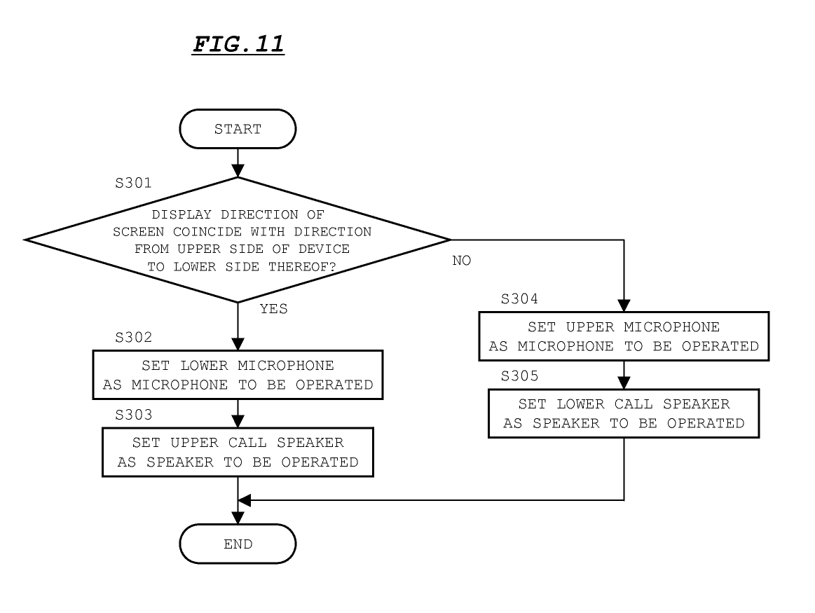

FIG. 11 is a flowchart of the setting switching process in the present modification. In the following, the setting switching process is described referring to FIG. 11.

When a locked state is released by a lock release process, a setting switching process is executed. The setting switching module 32 determines whether a home screen after a locked state is released is displayed on the display surface 3 so that the display direction of the home screen coincides with a direction from the upper side of the mobile phone 1 to the lower side thereof (S301).

When a home screen is displayed on the display surface 3 so that the display direction of the home screen coincides with a direction from the upper side of the mobile phone 1 to the lower side thereof (S301: YES), the setting switching module 32 sets the lower microphone 51 as a microphone to be operated (S302), and sets the upper call speaker 54 as a speaker to be operated (S303). According to this control, when a phone call is made, the lower microphone 51 and the upper call speaker 54 are operated, and sound uttered by the user is input to the lower microphone 51. Further, sound received from the mobile phone of the communication partner is output from the upper call speaker 54. Furthermore, when the user listens to a recorded message of an answering machine, the upper call speaker 54 is operated, and the recorded message is output from the upper call speaker 54.

On the other hand, when a home screen is displayed on the display surface 3 so that the display direction of the home screen coincides with a direction from the lower side of the mobile phone 1 to the upper side thereof (S302: NO), the setting switching module 32 sets the upper microphone 52 as a microphone to be operated (S304), and sets the lower call speaker 53 as a speaker to be operated (S305). According to this control, when a phone call is made, the upper microphone 52 and the lower call speaker 53 are operated, and sound uttered by the user is input to the upper microphone 52. Further, sound received from the mobile phone of the communication partner is output from the lower call speaker 53. Furthermore, when the user listens to a recorded message of an answering machine, the lower call speaker 53 is operated, and the recorded message is output from the lower call speaker 53.

According to this configuration, when the user holds the mobile phone 1 upside down, and displays a home screen in a display direction in accordance with the orientation of the mobile phone 1, the user is allowed to make a phone call and listen to a recorded message while holding the mobile phone 1 upside down, without changing the orientation of the mobile phone 1.

### Third Modification

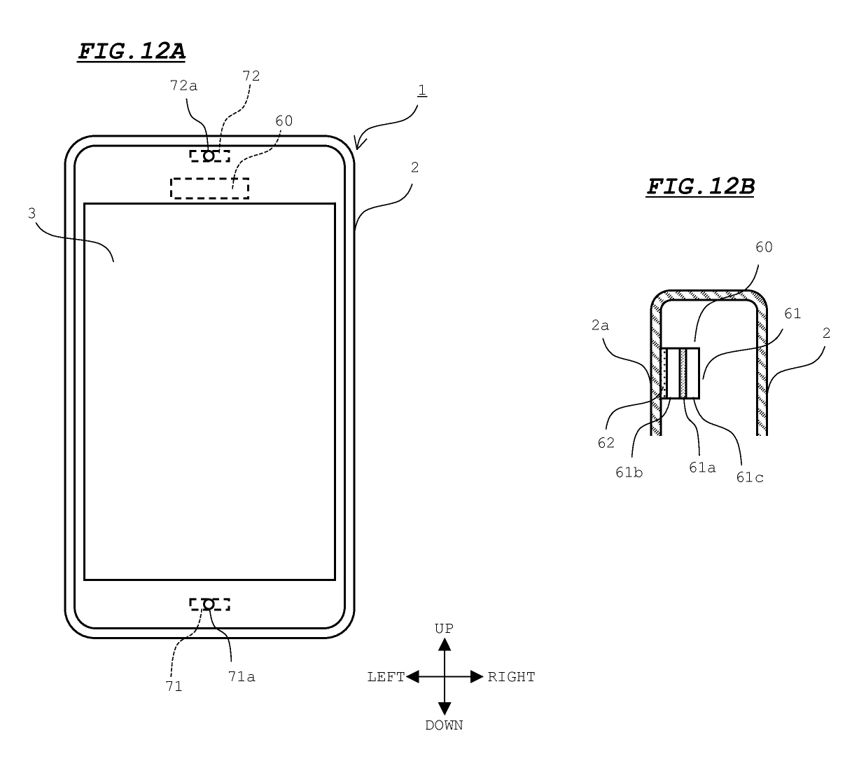

FIGS. 12A and 12B are diagrams of a configuration of a mobile phone 1 in a third modification. The description of the present modification about the same configuration as the mobile phone 1 in an embodiment is omitted herein. FIG. 12A is a front view of the mobile phone 1. FIG. 12B is a partial sectional view of a cabinet 2, showing a configuration of a call speaker 60. In FIG. 12B, illustrations of an upper microphone 72 and of an upper microphone hole 72a are omitted.

The call speaker 5 in an embodiment is a so-called air-conduction speaker, and is configured to output a sound wave associated with sound. In the present modification, as illustrated in FIG. 12B, the call speaker 60 constituted of a piezoelectric vibration element 61 may be disposed on the upper portion of the cabinet 2, in place of the call speaker 5.

The piezoelectric vibration element 61 may have a bimorph structure, and may include a shim member 61a, and a first piezoelectric ceramic plate 61b and a second piezoelectric ceramic plate 61c mounted on both sides of the shim member 61.

An alternate-current voltage is applied to each of the first piezoelectric ceramic plate 61b and to the second piezoelectric ceramic plate 61c. The alternate-current voltage to be applied to the first piezoelectric ceramic plate 61b, and the alternate-current voltage to be applied to the second piezoelectric ceramic plate 61c are displaced from each other in phase by 180 degrees. By applying an alternate-current voltage, an operation of expanding the first piezoelectric ceramic plate 61b and contracting the second piezoelectric ceramic plate 61c, and an operation of contracting the first piezoelectric ceramic plate 61b and expanding the second piezoelectric ceramic plate 61c are alternately repeated, whereby the piezoelectric vibration element 61 is vibrated.

The piezoelectric vibration element 61 may be mounted on the inner surface of a front surface 2a of the cabinet 2 with an adhesive agent 62.

The piezoelectric vibration element 61 is vibrated based on an electrical signal associated with sound. When the piezoelectric vibration element 61 is vibrated, vibration associated with the sound is transmitted to the front surface 2a of the cabinet 2, whereby the front surface 2a is vibrated.

When the user brings his/her ear near the upper portion of the front surface 2a of the cabinet 2 or brings his/her ear into contact with the upper portion of the front surface 2a of the cabinet 2, a sound wave generated by vibration of the cabinet 2 enters the ear canal through the ear hole. The entered sound wave travels through the ear canal, and vibrates the eardrum. In this way, sound is perceived in the user's brain. Further, when the user brings his/her ear into contact with the front surface 2a of the cabinet 2, the ear cartilage vibrates by vibration of the cabinet 2, the vibration of the ear cartilage is transmitted to the eardrum, and the eardrum vibrates. In this way, sound is perceived in the user's brain.

When the call speaker 60 is operated, the entirety of the front surface 2a of the cabinet 2 is vibrated. Therefore, even when the user brings his/her ear into contact with the lower portion of the cabinet 2 while holding the mobile phone 1 upside down, the user can catch the sound output from the call speaker 60, e.g. a recorded message.

The call speaker 60 i.e. the piezoelectric vibration element 61 may not be mounted on the back surface of an upper frame portion of a display surface 3 as described above, but may be mounted on the back surface of a display module 13.

Further, in the present modification, as well as the second modification, a lower microphone 71 and an upper microphone 72 may be disposed at a lower end and an upper end of the cabinet 2, respectively. Sound is input to the lower microphone 71 and to the upper microphone 72 through a lower microphone hole 71a and through an upper microphone hole 72a, respectively.

Further, in the present modification, as well as the second modification, a control module 11 may include a setting switching module 32. The setting switching module 32 in the present modification executes a setting switching process of switching between setting the lower microphone 71 as a microphone to be operated, and setting the upper microphone 72 as a microphone be operated.

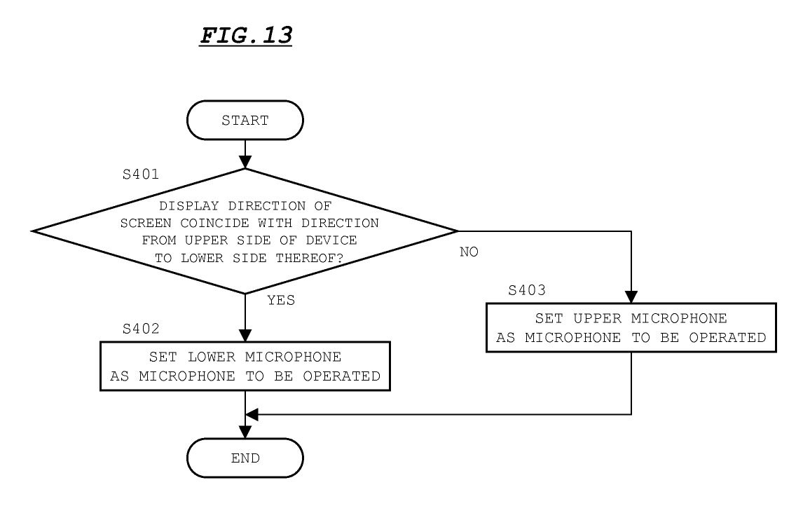

FIG. 13 is a flowchart of the setting switching process in the present modification. When a home screen is displayed on the display surface 3 so that the display direction of the home screen coincides with a direction from the upper side of the mobile phone 1 to the lower side thereof (S401: YES), the setting switching module 32 sets the lower microphone 51 as a microphone to be operated (S402). According to this control, when a phone call is made, the lower microphone 71 is operated, and sound uttered by the user is input to the lower microphone 71.

On the other hand, when a home screen is displayed on the display surface 3 so that the display direction of the home screen coincides with a direction from the lower side of the mobile phone 1 to the upper side thereof (S401: NO), the setting switching module 32 sets the upper microphone 52 as a microphone to be operated (S403). According to this control, when a phone call is made, the upper microphone 72 is operated, and sound uttered by the user is input to the upper microphone 72.

According to this configuration, even when the user makes a phone call while holding the mobile phone 1 upside down, the user can catch the sound received from the call speaker 60, and can input uttered sound to the upper microphone 72. In this way, the user is allowed to make a phone call while holding the mobile phone 1 upside down.

### Other Modifications

In the foregoing, an embodiment and modifications have been described. The present disclosure, however, is not limited by the foregoing embodiment and modifications. Further, an embodiment may be modified in various ways other than the above.

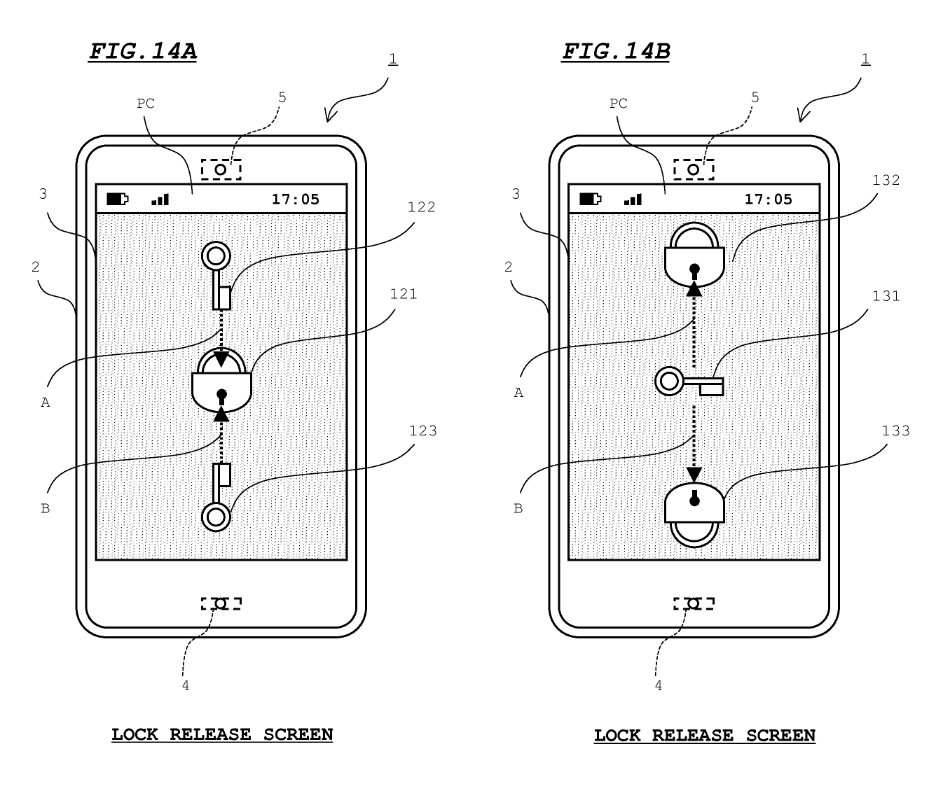

For instance, in an embodiment, a locked state is released when the user performs a flick operation or a slide operation with respect to the first release object 101 or with respect to the second release object 102 on the first release area R1 or on the second release area R2, which is set around the first release object 101 or around the second release object 102. The disclosure is not limited to the aforementioned configuration. For instance, a lock release screen may be configured as illustrated in FIGS. 14A and 14B.

On the lock release screen illustrated in FIG. 14A, a first key-shaped object 122 and a second key-shaped object 123, each of which is a release object in the form of a key, are disposed on the upper side and the lower side with respect to a lock-shaped object 121, which serves as a release area in the form of a lock. As illustrated by the arrow A, when a flick operation or a slide operation of moving the first key-shaped object 122 to the lock-shaped object 121 is performed, as illustrated in the right drawing of FIG. 6A, a release control module 31 displays a home screen on a display surface 3, whose display direction coincides with a direction from the upper side of a mobile phone 1 to the lower side thereof. On the other hand, as illustrated by the arrow B, when a flick operation or a slide operation of moving the second key-shaped object 123 to the lock-shaped object 121 is performed, as illustrated in the right drawing of FIG. 6B, the release control module 31 displays a home screen on the display surface 3, whose display direction coincides with a direction from the lower side of the mobile phone 1 to the upper side thereof.

On the lock release screen illustrated in FIG. 14B, a first lock-shaped object 132 and a second lock-shaped object 133, each of which serves as a release area in the form of a lock, are disposed on the upper side and the lower side with respect to a key-shaped object 131, which is a release object in the form of a key. As illustrated by the arrow A, when a flick operation or a slide operation of moving the key-shaped object 131 to the first lock-shaped object 132 is performed, as illustrated in the right drawing of FIG. 6A, the release control module 31 displays a home screen on the display surface 3, whose display direction coincides with a direction from the upper side of the mobile phone 1 to the lower side thereof. On the other hand, as illustrated by the arrow B, when a flick operation or a slide operation of moving the key-shaped object 131 to the second lock-shaped object 133 is performed, as illustrated in the right drawing of FIG. 6B, the release control module 31 displays a home screen on the display surface 3, whose display direction coincides with a direction from the lower side of the mobile phone 1 to the upper side thereof.

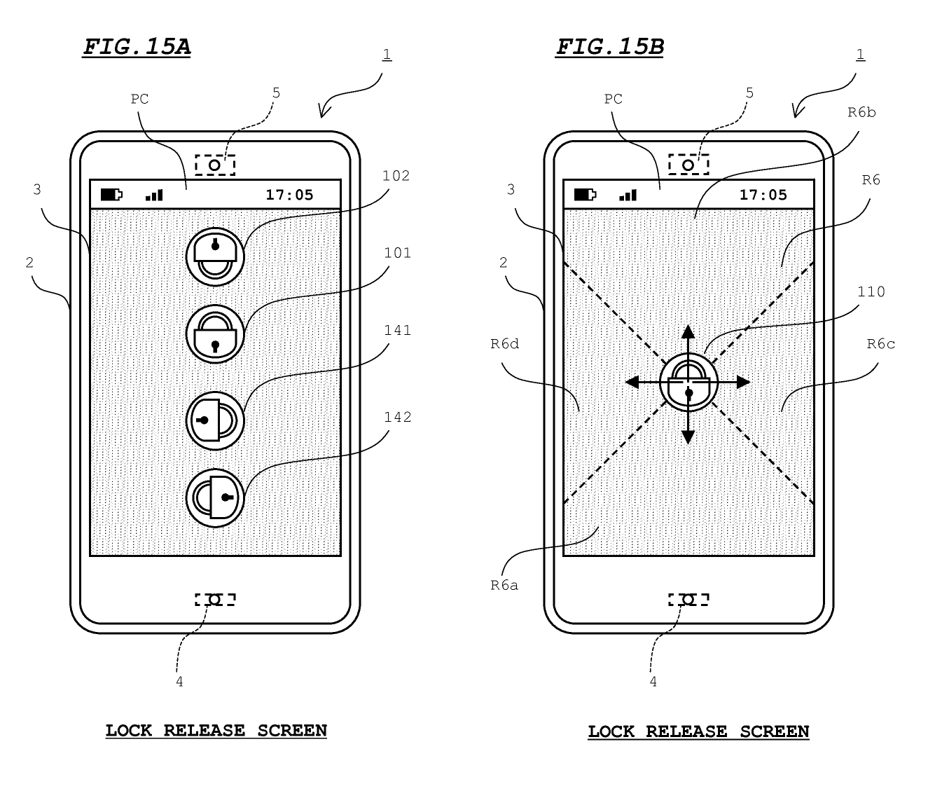

Further, in an embodiment, the first release object 101 and the second release object 102 are displayed on a lock release screen. The disclosure is not limited to the aforementioned configuration. As illustrated in FIG. 15A, a fourth release object 141 and a fifth release object 142 may be displayed on a lock release screen, in addition to the first release object 101 and the second release object 102. In this case, a fourth release area (not illustrated) is set around the fourth release object 141, and a fifth release area (not illustrated) is set around the fifth release object 142. When a flick operation or a slide operation of moving the fourth release object 141 to the fourth release area is performed, a release control module 31 displays a home screen on a display surface 3, whose display direction coincides with a direction from the right side of a mobile phone 1 to the left side thereof. When a flick operation or slide operation of moving the fifth release object 142 to the fifth release area is performed, the release control module 31 displays a home screen on the display surface 3, whose display direction coincides with a direction from the left side of the mobile phone 1 to the right side thereof.

Further, in the first modification, the third release area R3 constituted of the lower area R3a and the upper area R3b is set on the display surface 3 (a lock release screen).

The disclosure is not limited to the aforementioned configuration. As illustrated in FIG. 15B, a sixth release area R6 constituted of a lower area R6a, an upper area R6b, a right area R6c, and a left area R6d may be set on the display surface 3. In this case, when a flick operation or a slide operation of moving the third release object 110 to the left area R6d is performed, a release control module 31 displays a home screen on the display surface 3, whose display direction coincides with a direction from the right side of a mobile phone 1 to the left side thereof. When a flick operation or a slide operation of moving the third release object 110 to the right area R6c is performed, the release control module 31 displays a home screen on the display surface 3, whose display direction coincides with a direction from the left side of the mobile phone 1 to the right side thereof.

Further, in an embodiment, each of the first release object 101 and the second release object 102 includes display of a lock. Alternatively, each of the first release object 101 and the second release object 102 may include display of an image other than a lock.

Further, in an embodiment, a home screen is displayed when a locked state is released. Alternatively, a screen other than a home screen, for instance, a screen that has been displayed on the display surface 3 before the locking function is operated, may be displayed.

Further, in the mobile phone 1 in the third modification, the call speaker 60 is provided in place of the call speaker 5, and the lower microphone 71 and the upper microphone 72 are provided in place of the microphone 4. Alternatively, the mobile phone 1 may be configured to include a call speaker 60 in place of the call speaker 5, while keeping a microphone 4. According to this configuration, the user can catch the sound output from the call speaker 60 such as a recorded message while holding the mobile phone 1 upside down.

The present disclosure is not limited to a mobile phone, and may be applicable to mobile terminal devices of various types such as a PDA (Personal Digital Assistant), a tablet PC, and an electronic book terminal.

An embodiment of the present disclosure is applicable to various modifications other than the above, as necessary, as far as such modifications do not depart from the technical scope of the present disclosure as defined in the claims.

What is claimed is:

1. A mobile terminal device, comprising:
a display module including a display surface;
an operation receiving module configured to receive a first operation and a second operation from a user, the second operation being different from the first release operation; and
control module configured to:
set a locked state, in which receiving of at least a part of operations from a user is restrained,
release the locked state and display a predetermined screen in a first display direction associated with the first release operation, if the first release operation is received, and
release the locked state and display the predetermined screen in a second display direction associated with the second release operation, if the second release operation is received, the second display direction being different from the first display direction.

2. The mobile terminal device according to claim 1, wherein
the control module displays a release screen for releasing the locked state on the display surface, and
the operation receiving module receives the first release operation and the second release operation on the release screen.

3. The mobile terminal device according to claim 2, wherein
the operation receiving module receives a touch operation with respect to the display surface,
the release screen comprises a first release object and a second release object to be operated,
the first release operation comprises a touch operation accompanying movement of a touch position with respect to the first release object, and
the second release operation comprises a touch operation accompanying movement of a touch position with respect to the second release object.

4. The mobile terminal device according to claim 3, wherein
the first release object comprises display indicating the first display direction, and
the second release object comprises display indicating the second display direction.

5. The mobile terminal device according to claim 2, wherein
the operation receiving module receives a touch operation with respect to the display surface,
the release screen comprises a release object to be operated,
the first release operation comprises a touch operation accompanying movement of a touch position with respect to the release object, and
the second release operation comprises a touch operation accompanying movement of a touch position with respect to the release object in a direction different from a direction of the first release operation.

6. The mobile terminal device according to claim 1, wherein
the first display direction is a direction from an upper side of the mobile terminal device to a lower side of the mobile terminal device, and
the second display direction is a direction from the lower side of the mobile terminal device to the upper side of the mobile terminal device.

7. The mobile terminal device according to claim 6, further comprising:
a first speaker and a second speaker respectively disposed on an upper side and a lower side of a body of the mobile terminal device, and configured to output sound;
a first microphone and a second microphone respectively disposed on the upper side and the lower side of the body of the mobile terminal device, and configured to input sound; and
a setting switching module configured to set the first speaker and the second microphone respectively as a speaker to be operated and a microphone to be operated when the predetermined screen is displayed on the display surface in the first display direction, and configured to set the second speaker and the first microphone respectively as a speaker to be operated and a microphone to be operated when the predetermined screen is displayed on the display surface in the second display direction.

8. The mobile terminal device according to claim 6, further comprising:
a speaker configured to release a sound wave associated with sound to be output, and a vibration wave to be generated by vibration of a body of the mobile terminal device based on vibration associated with the sound to be output so as to transmit sound to the user.

9. The mobile terminal device according to claim 8, further comprising:
a first microphone and a second microphone respectively disposed on an upper side and a lower side of a body of the mobile terminal device, and configured to input sound; and
a setting switching module configured to set the second microphone as a microphone to be operated when the predetermined screen is displayed on the display surface in the first display direction, and configured to set the first microphone as a microphone to be operated when the predetermined screen is displayed on the display surface in the second display direction.

10. A non-transitory computer readable storage medium comprising computer-executable instructions for operating a mobile terminal device provided with a display module including a display surface, and an operation receiving module configured to receive a first operation and a second operation from a user, the second operation being different from the first release operation, wherein the computer-executable instructions comprise:
setting a locked state, in which receiving of at least a part of operations from a user is restrained;
releasing the locked state and displaying a predetermined screen in a first display direction associated with the first release operation, if the first release operation is received; and
releasing the locked state and displaying the predetermined screen in a second display direction associated with the second release operation, if the second release operation is received, the second display direction being different from the first display direction.

11. A display control method, comprising:
setting a locked state, in which receiving of at least a part of operations from a user is restrained;
if a first release operation from a user is received, releasing the locked state and displaying a predetermined screen in a first display direction associated with the first release operation; and
if a second release operation from a user is received, releasing the locked state and displaying the predetermined screen in a second display direction associated with the second release operation, the second release operation being different from the first release operation, and the second display direction being different from the first display direction.
